(19) United States
(12) Patent Application Publication
(10) Pub. No.: US 2022/0164154 A1
(43) Pub. Date: May 26, 2022

(54) VIRTUAL PLAYOUT SCREEN FOR VISUAL MEDIA USING ARRANGEMENT OF MOBILE ELECTRONIC DEVICES

(71) Applicant: Telefonaktiebolaget LM Ericsson (publ), Stockholm (SE)

(72) Inventors: Peter Ökvist, LULEÅ (SE); Tommy Arngren, SÖDRA SUNDERBYN (SE); David Lindero, LULEÅ (SE)

(21) Appl. No.: 17/601,818

(22) PCT Filed: Apr. 10, 2019
(86) PCT No.: PCT/EP2019/059077

§ 371 Date: Oct. 6, 2021

(51) Int. Cl. G06F 3/14; G06F 3/0346; G06T 7/20; G06T 3/40; G06F 3/0484

(52) U.S. Cl. CPC G06F 3/1446; G06F 3/0346; G06F 3/0484; G06T 3/40; G06T 7/20

(57) ABSTRACT

A mobile electronic device (MD) operates with an arrangement of MDs to provide a virtual playout screen for visual media. A movement sensor senses movement of the MD. Processor operations include generating a movement vector identifying direction and distance that the MD has been moved from a reference location to a playout location where it will form a component of the virtual playout screen, based on tracking movement indicated by the movement sensor while being moved. The operations provide the movement vector to a media splitting module that determines how to split the visual media into a set of cropped portions for display on assigned ones of the MDs based on the movement vector. The operations obtain a cropped portion of the visual media that has been assigned by the media splitting module to the MD, and display the cropped portion of the visual media on a display device.

### TECHNICAL FIELD

The present disclosure relates to a mobile electronic device configured for operation with an arrangement of mobile electronic devices to provide a virtual playout screen for visual media, a media server configured for communication with an arrangement of mobile electronic devices that provide a virtual playout screen for visual media, corresponding methods, and corresponding computer program products.

### BACKGROUND

Mobile electronic devices, such as mobile phones, are increasingly being used for video services, such as gaming applications, social media applications, live peer-to-peer video streaming communications (e.g., Facetime, etc.), and entertainment applications (e.g., Netflix, YouTube, etc.). Mobile electronic devices necessarily have limitations on their display size, resolution, and processing capabilities in order to facilitate mobility, aesthetics and longer battery life. A concept called “Junkyard Jumbotron” has been proposed for transforming the display devices of a group of mobile electronic devices into a virtual larger display that is used to display an image. This concept requires a user to send a photo of the arranged mobile electronic devices to a network server, which analyzes the photo to determine the layout of the display devices and how to slice-up and distribute an image to the mobile electronic devices for collective display. This concept requires certain joint operational capabilities of the mobile electronic devices and the connected server and requires involvement of users which create significant limitations to this concept being deployed for use with visual media playout.

### SUMMARY

Some embodiments disclosed herein are directed to a mobile electronic device that is configured for operation with an arrangement of mobile electronic devices to provide a virtual playout screen for visual media. The mobile electronic device includes a wireless network interface circuit, a movement sensor, a display device, a processor, and a memory. The wireless network interface circuit is configured for communication through a wireless communication link. The movement sensor is configured to sense movement of the mobile electronic device. The processor operationally connects the display device, the movement sensor, and the wireless network interface circuit. The memory stores program code that is executed by the processor to perform operations. The operations include generating a movement vector identifying direction and distance that the mobile electronic device has been moved from a reference location to a playout location where the display device will form a component of the virtual playout screen based on tracking movement indicated by the movement sensor of the mobile electronic device while being moved. The operations provide the movement vector to a media splitting module that determines how to split the visual media into a set of cropped portions for display on assigned ones of the mobile electronic devices based on the movement vector. The operations obtain a cropped portion of the visual media that has been assigned by the media splitting module to the mobile electronic device, and then display the cropped portion of the visual media on the display device.

A potential advantage of these operations is that a more optimally configured virtual playout screen can be more automatically created through use of the movement vectors generated from output of the movement sensor. These operations can be performed independently of any server such as by a master one of the mobile electronic devices and/or may be performed a combination of a media server and the mobile electronic devices. This enables many more options for what component of the system determines the layout of the mobile electronic devices that will provide the virtual playout screen and for what component of the system splits the visual media into the set of cropped portions for display through the mobile electronic devices.

Some other embodiments disclosed herein are directed to a media server configured for communication with an arrangement of mobile electronic devices that provide a virtual playout screen for visual media. The media server includes a network interface circuit, a processor, and a memory. The network interface circuit is configured for communication with the mobile electronic devices. The processor is operationally connected to the network interface circuit. The memory stores program code that is executed by the processor to perform operations. The operations include receiving movement vectors from the mobile electronic devices, where each of the movement vectors identifies direction and distance that one of the mobile electronic devices have been moved from a reference location to a playout location where a display device of the mobile electronic device will form a component of the virtual playout screen. The operations split the visual media into a set of cropped portions for display on assigned ones of the mobile electronic devices based on the movement vectors. The operations also route the cropped portions of the visual media toward the assigned ones of the mobile electronic devices for display.

Other mobile electronic devices, media servers, and corresponding methods and computer program products according to embodiments of the inventive subject matter will be or become apparent to one with skill in the art upon review of the following drawings and detailed description. It is intended that all such additional mobile electronic devices, media servers, methods, and computer program products be included within this description, be within the scope of the present inventive subject matter and be protected by the accompanying claims. Moreover, it is intended that all embodiments disclosed herein can be implemented separately or combined in any way and/or combination

### BRIEF DESCRIPTION OF THE DRAWINGS

Aspects of the present disclosure are illustrated by way of example and are not limited by the accompanying drawings. In the drawings:

FIG. 1 illustrates a side view of a set of mobile electronic devices that have been stacked to form an initial arrangement relative to a reference location in accordance with one embodiment of the present disclosure;

FIG. 2 illustrates the set of mobile electronic devices that have been rearranged by a user to provide a virtual playout screen for visual media and with the mobile electronic devices generating respective movement vectors that are used for splitting of visual media into a set of cropped portions that are distributed to assigned ones of the mobile electronic devices in accordance with some embodiments of the present disclosure;

FIG. 3 is a combined flowchart and data flow diagram illustrating operations that are performed by the set of mobile electronic devices in accordance with some embodiments of the present disclosure;

FIG. 4 is another combined flowchart and data flow diagram illustrating operations that are performed by a combination of the media server and the set of mobile electronic devices in accordance with some embodiments of the present disclosure;

FIGS. 5-7 are flowcharts of operations that are performed by a master one of the mobile electronic devices in accordance with some embodiments of the present disclosure;

FIG. 8 is a flowchart of operations that are performed by a media server in accordance with some embodiments of the present disclosure;

FIG. 9 is a block diagram of components of a mobile electronic device which are configured to operate in accordance with some embodiments of the present disclosure; and

FIG. 10 is a block diagram of components of a media server which are configured to operate in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

Some embodiments are directed to methods and operations by mobile electronic devices and a media server to display visual media through a virtual playout screen that is provided by an arrangement of mobile electronic devices. Methods and operations for splitting the visual media into a set of cropped portions that are assigned for playback by the set of mobile electronic devices may be performed by one of the mobile electronic devices functioning as a master device or may be performed by the media server. These approaches enable many more options for how the system determines the present layout of the mobile electronic devices to provide the virtual playout screen for the visual media, and which can reduce the technical complexity and cost of implementing virtual playout screens both to the software developers and to the end-users.

First Aspects of Visual Media Splitting and Display Operations:

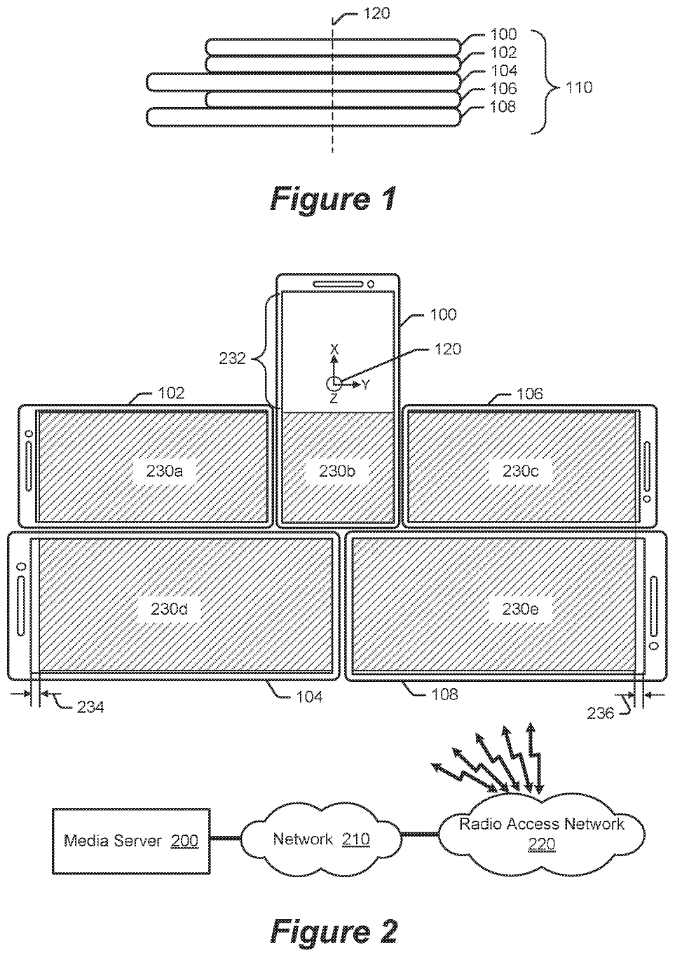

Various operations are now described in the context of the non-limiting embodiment of FIGS. 1 and 2 which provide a virtual playout screen for visual media using an arrangement of mobile electronic devices. For brevity and without limitation, a “mobile electronic device” is also abbreviated as a “MD” and referred to as a “mobile device” and “device.” The visual media may be a single photo, a plurality of photos, video, a graphical image, an animated graphic, or any other data that can be visually displayed on a display device.

FIG. 1 illustrates a side of a set of mobile electronic devices (MDs) MD1-MD5, collectively referred to as 110, that have been stacked to form an initial arrangement relative to a reference location 120 in accordance with one embodiment of the present disclosure. Referring to FIG. 1, a user has stacked MD1-MD5 with alignment along a common edge. Users have downloaded an application to their MDs 110 that performs operations that facilitate creation of the virtual playout screen using the MDs 110. A user triggers an event that is operationally sensed and indicates to the application that the user will now be moving individual ones of the MDs 110 from the stacked arrangement to an arrangement that is spaced apart and configured to provide the virtual playout screen for playout of the visual media.

The MDs 110 can be configured to sense the user's triggering event by many alternative ways. One way that an MD can sense the event is by sensing when a user taps on a topmost one of the stacked MDs 110 or when a user taps on a table or other structure supporting the MDs 110. Another way that an MD can sense the event is by sending an audible trigger, such as a knock sound, clap sound, spoken or other user audible command still another way that an MD can sense the event is through receiving a defined user input through a user interface of the MD, such as a touch screen interface and/or mechanical button. Each of the MDs 110 may operate to separately identify occurrence of the triggering event or only one of the MDs 110, such as a master MD, may operate to identify occurrence of the triggering event and then notify the other MDs 110 through wireless communication link that the triggering event has been sensed.

The MDs track their movement while being moved responsive to determining or being informed of the triggering event, and stop tracking their movement and generate a movement vector responsive to another event. For example, the application may display a prompt to the user with a movement start/stop icon which is selected (e.g., tapped) to initiate tracking of movement by the MDs 110 and which is further selected to cease tracking movement and generate movement vectors, and initiate further operations by one or more of the applications and/or by a media server to determine how to split a visual media into a set of cropped portions for display on assigned ones of the MDs 110 based on the tracked movement, and cause the cropped potions to be distributed to the assigned ones of the MDs 110 for playout through the virtual playout screen. Alternatively, each of the MDs 110 may generate a movement vector that is communicated to the master MD or to the media server when the MD has remained stationary for at least a threshold time after being moved.

Further example operations are now explained in the context of the example movements of the MDs 110 from the initial stacked arrangement shown in FIG. 1 to the virtual playout screen arrangement shown FIG. 2. Referring to FIGS. 1 and 2, the user makes an input that triggers the event which causes the topmost MD1 to begin tracking its movement relative to the reference location 120 using internal movement sensors. The user moves (rotates to portrait orientation and translates) the topmost MD1 to where its display device is desired to form a component of the virtual playout screen. The user then makes another input that triggers MD1 to stop tracking its movement and to generate a movement vector identifying a direction and distance that the MD1 has been moved from a reference location 120 to a playout location where a display device of MD1 will form a component of the virtual playout screen. MD1 may notify MD2-MD5 through a wireless communications link of occurrence of the trigger event. Alternatively MD2-MD5 may each separately sense the trigger event, such as described below in the following non-limiting example in which the user then sequentially repeats the operations with the other MD2, MD3, MD4, and then MD5 to arrange MD1-MD5 as the user desires for their respective screens to be used as components of the virtual playout screen for playout of visual media.

In particular, the user next repeats the process using the now topmost MD2 by making and input to trigger the event which causes the MD2 to begin tracking its movement relative to the reference location 120 while the user moves (rotates to landscape mode and translates) MD2 to the left of MD1 with a side edge of MD2 aligned with a bottom edge of MD1, and then makes the other input to stop tracking movement and generate a movement vector. The user next repeats the process using the now topmost MD3 by making an input to trigger the event which causes MD3 to begin tracking its movement relative to the reference location 120 while the user moves MD3 to have a side edge below and immediately adjacent to the lower side edge of MD2 and the bottom edge of MD1 and rotated to landscape mode, and then makes the other input to stop tracking movement and generate a movement vector. The user next repeats the process using the now topmost MD4 by making an input to trigger the event which causes MD4 to begin tracking its movement relative to the reference location 120 while the user moves MD4 to the right of MD1 with a side edge of MD4 aligned with a bottom edge of MD1 and rotated in landscape mode, and then makes the other input to stop tracking movement and generate a movement vector. The user next repeats the process using the remaining MD5 by making the input which triggers the event which causes MD5 to begin tracking its movement relative to the reference location 120 while the user moves MD5 below MD1 and MD4 and rotated in landscape mode, and then making the other input to stop tracking movement and generate a movement vector.

Although the MD movements illustrated between FIGS. 1 and 2 may be primarily rotational and translational along a plane, the movement sensors and tracking operations can be configured to track movement with respect to any number of axes, such as along three orthogonal axes and rotations about any one or more of the axes. Thus, for example, a user may rearrange the MDs 110 to provide a non-planar three-dimensional arrangement of the MDs 110 to create the virtual playout screen. Moreover, it is to be understood that the initial arrangement of the MDs 110 does not need to be a single stack or that the arrangement needs to be stacked at all. For example, some of the MDs 110 may initially be arranged partially overlapping while some other MDs 110 may be separately spaced apart therefrom. However, when arranged in a manner other than an aligned stack, the MDs 110 should operate to track their movements relative to a common reference location, for example, using RF-based or sound-based time-of-flight ranging and triangulation, satellite positioning, cellular assisted positioning, WiFi access point assisted positioning, and/or another positioning technology to determine their locations relative to each other when arranged to form the virtual playout screen. An MD may be configured to provide the user with a predefined set of arrangements for the MDs from which the user may select, where each of the arrangements in the predefined set may have different orientations and/or edge alignments between the MDs (e.g., stack with aligned upper left corners, spread-out arranged side-by-side in a row, spread-out arranged top-to-bottom in a column, etc.)

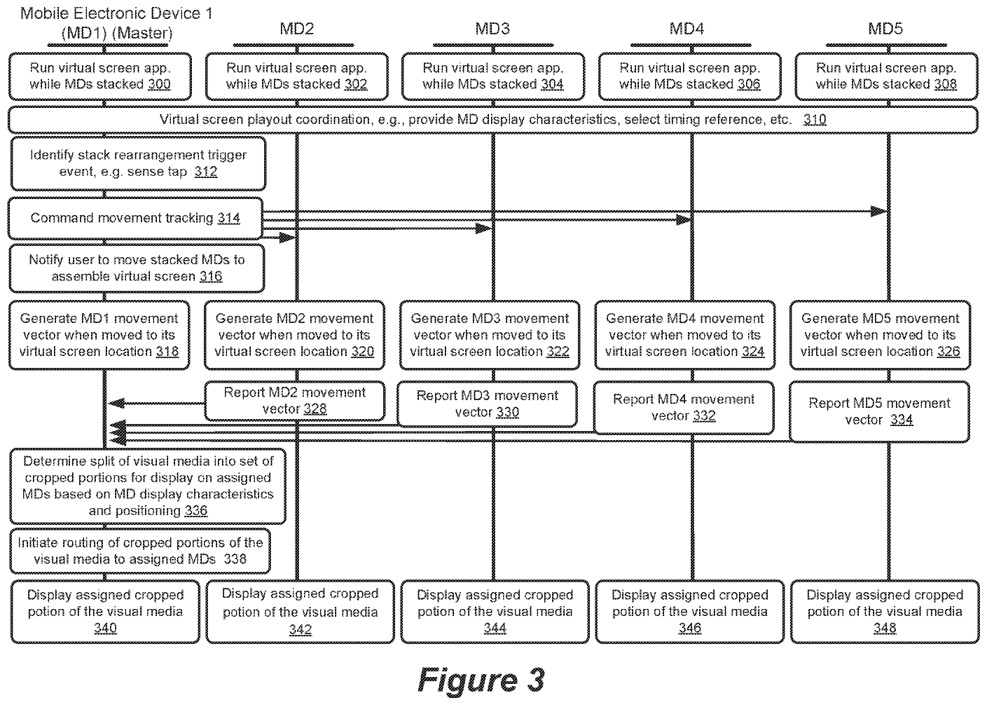

FIG. 3 is a combined flowchart and data flow diagram illustrating operations that are performed by the set of mobile electronic devices (MD1, MD2, MD3, MD4, MD5) in accordance with some embodiments of the present disclosure.

For the example operations, MD1 is assumed to operate as a master as explained below. MD1 may be selected from among the MDs 110 to operate as a master device based on comparison of one or more capabilities of the MDs 110. For example, MD1 may be selected as the master based on it having the greatest processing capabilities, highest quality of service link to the media server 200, and/or another highly ranked capability. Alternatively or additionally, the media server 200 may select the master device from among the MDs 110 and/or the user may select which of the MDs 110 will operate as the master.

Referring to FIG. 3, each of MD1-MD5 operate to run 300-308 a virtual screen application while they are arranged in a stacked configuration, although the operations are not limited to use with stacked configurations as explained above. The application performs a virtual screen playout coordination operation 310 through wireless communications between MD1 and the other MD2-MD5. The coordination operation 310 can include having each of MD2-MD5 separately report their display characteristics to MD1 or share their display characteristics with each other. The display characteristics may include any one or more of physical size of the display, physical size of the MD, display aspect ratio, display resolution, display framing width and/or thickness, display color temperature, media processing capability, memory availability, best communication link quality to a potential media server, and/or other characteristics associated with how the MD can display visual media. The coordination operation 310 can include having MD1-MD5 agree on a common timing reference, e.g., radio network timestamp, satellite positioning system signal (e.g., GPS or GNSS signal timing), and/or a signal from a network time protocol (NTP) server, which can be used for synchronizing playout of an assigned portion of the visual media according to further operations below.

MD2-MD5 may separately communicate with MD1 using any wireless communication protocol, although a low latency protocol such as a device-to-device communication protocol may be particularly beneficial. The wireless communication protocol may be, for example, use side-link communication features of LTE or New Radio (NR) or may use a cellular radio interface for communications through a radio base station, which may preferably have a relatively low communication around-trip time (e.g., less than 3 ms for NR).

MD1 identifies occurrence of a trigger event, which as described above may correspond to a movement sensor (e.g., accelerometer) sensing a user tapping on a housing or supporting table of MD1, or may correspond to a touchscreen interface or physical switch sensing a defined user input, or may correspond to an audio input such as a spoken command identified via Apple's Siri feature. To reduce the likelihood of falsely identified trigger events, MD1 may require a defined sequence to be sensed, such as a distinct knock sequence. Responsive to sensing the trigger event, MD1 starts tracking its movement via a movement sensor and may communicate 314 a movement tracking command to MD2-MD5 to cause them to start tracking their movement when the user separately moves each of MD2-MD5 to where the user desires the respective display devices to form components of the virtual playout screen. Alternatively as described above for FIGS. 1 and 2, each of MD2-MD5 may separately sense when the user taps or otherwise inputs the event to trigger their movement tracking.

Responsive to identifying 312 the trigger event, MD1 may notify 316 the user to move at least MD1 to its desired location for the virtual playout screen. MD1 tracks its movement via the movement sensor while being moved by the user. Responsive to the user entering another input and/or sensing no further movement during a threshold elapsed time, MD1 generates 318 a movement vector identifying direction and distance that the MD1 has been moved from a reference location 120 to a playout location where the display device will form a component of the virtual playout screen, based on tracking movement indicated by the movement sensor while being moved. The movement vector may indicate the distance and direction along one or more axes that MD1 moved from the reference location 120 to the final resting location. The movement vector may additionally or alternatively indicate rotation(s) of MD1 along one or more axes that MD1 moved relative to the reference location 120. MD2-MD5 similarly track their movement when separately moved by the user to their respective locations to form the virtual playout screen, and generate 320-326 respective movement vectors indicating their locations relative to the reference location 120. MD2-MD5 can separately report 328-334 their generated movement vectors to MD1, which serves as the master according to this example embodiment.

MD1 provides the movement vectors to a media splitting module that determines how to split the visual media into a set of cropped portions for display on assigned ones of MD1-MD5 based on their respective movement vectors, and which may be further determined based on the individual display characteristics of each of MD1-MD5. According to the embodiment of FIG. 3, MD1 performs 336 the media splitting module operations and initiates 338 routing of the cropped portions of the visual media to the assigned MD1-MD5 for display.

MD1 operating as the master initiates coordinated playout of the visual media using the cropped portions thereof and the arrangement of the virtual play out screen. The operations for performing the coordinated playout can vary depending upon which element of the system generates the cropped portions of the media server.

Referring to FIG. 2, the system can include a media server 200 that communicates through a data network 210 (e.g., public Internet and/or private network) and a radio access network 220 with one or more of the MDs 110. The media server 200 may store the visual media for distribution to one or more of the MDs 110. Three scenarios for which system element operates to generate the cropped portions of the visual media are: 1) the master MD1 generates the cropped portions of the visual media for distribution to MD2-MD5 from a copy of the visual media stored in their local memory or from the media server 200; 2) each of the MD1-MD5 generate their own cropped portion from a copy of the visual media stored in their local memory or from the media server 200; and 3) the media server 200 generates the cropped portions of the visual media from a copy in local memory for distribution to MD1-MD5.

According to the first scenario the master MD1 generates the cropped portions of the visual media, MD1 can perform the operations of the media splitting module to determine how to split the visual media into the set of cropped portions for display on assigned ones of the MD1-MD5, perform the operations to split the visual media into the cropped portions, and then distribute the assigned ones of the cropped portions to MD2-MD5 for display. MD1 may receive the visual media as a file or as a stream from the media server 200 or may have the visual media preloaded in a local memory. The distribution may be performed through a low latency protocol such as a device-to-device communication protocol, although other communication protocols may be used such as explained above.

According to the second scenario the master MD1 can perform the operations of the media splitting module to determine how to split the visual media into the set of cropped portions for display on assigned ones of the MD1-MD5, which results in generating splitting instructions. MD1 sends the splitting instructions for their respective use in performing the operations to split the visual media into their respective cropped portion that is to be locally displayed on a display device. MD1-MD5 may receive the visual media as a file or as a stream from the media server 200 or may have the visual media preloaded in a local memory. Alternatively, each of MD1-MD5 can operate in a coordinated manner to perform the operations of the media splitting module to determine how to split the visual media into the set of cropped portions for display on assigned ones of the MD1-MD5, which can result in generating the splitting instructions which they each use to control how the visual media is split into the cropped portions.

According to the third scenario the media server 200 generates the cropped portions of visual media from a copy in local memory for distribution to MD1-MD5. The media server 200 may locally perform the operations of the media splitting module to determine how to split the visual media into the set of cropped portions, may receive splitting instructions from MD1 that identify how the visual media is to be split for all of the MD1-MD5, or may receive splitting instructions individually from each of MD1-MD5 identifies how the visual media is to be split for the individual MD. For example, MD1 may operate to perform 336 the media splitting module operations to determine how many cropped portions that are to be generated and characteristics (e.g., size, aspect ratio, resolution, etc.) of the cropped portions which results in generating the splitting instructions, and provide the splitting instructions to the media server 200 to perform the media splitting operation and subsequent sending of the cropped portions to the assigned MD1-MD5. The media server 200 may send each of the cropped portions addressed for transmission directly to the assigned one of the MD1-MD5, or may communicate all of the cropped portions addressed to MD1 for forwarding to the assigned ones of the other MD2-MD5.

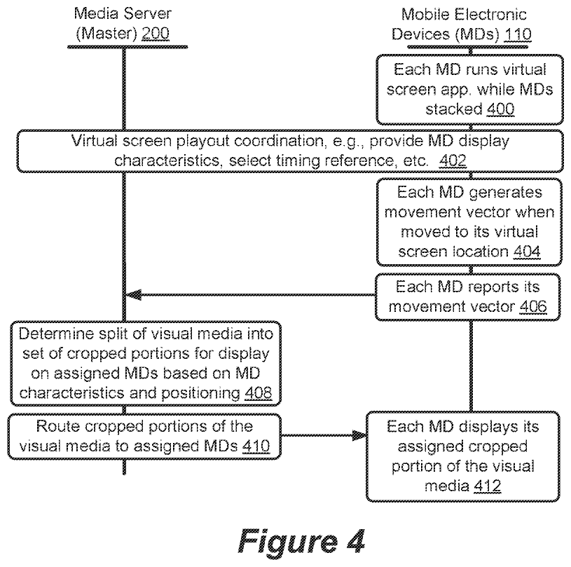

Regarding the third scenario, FIG. 4 is a combined flowchart and data flow diagram illustrating operations for the third scenario that are performed by a combination of the media server 200 and the set of MDs 110. Referring to FIG. 4, each of MD1-MD5 run 400 the virtual screen application. The media server 200 communicates with MD1-MD5, either directly or via MD1, to perform the virtual screen play out coordination operations 402, which may substantially correspond to the operation 310 of FIG. 3. For example, the coordination operation 402 can include having each of MD1-MD5 report their display characteristics to the media server 200. The display characteristics may include any one or more of physical size of the display, physical size of the MD, display aspect ratio, display resolution, display framing width and/or thickness, display color temperature, media processing capability, memory availability, best communication link quality to a potential media server, and/or other characteristics associated with how the MD can display visual media. The coordination operation 402 can include having MD1-MD5 agree on a common timing reference, e.g., radio network timestamp, satellite positioning system signal (e.g., GPS or GNSS signal timing), and/or a signal from a network time protocol (NTP) server, which can be used for synchronizing playout of an assigned portion of the visual media according to further operations below.

Each of MD1-MD5 generates 404 a movement vector when it is moved to its virtual screen location, and then reports 406 its movement vector to the media server 200. The media server 200 performs the operations of the media splitting module to determine 408 how to split the visual media into the set of cropped portions. The media server 200 generates the cropped portions of the visual media and then routes 410 the cropped portions to the assigned MD1-MD5. MD1-MD5 receive and display their respective assigned cropped portion of the visual media, he can control timing for when a cropped portion of an individual picture or when a crop portion of a video frame is displayed so that it occurs with timing synchronization across the set of MDs 110.

MD1-MD5 operate to display 340-348 their assigned cropped portion of the visual media so that the collection of cropped portions is played out through the virtual playout screen. In the example of FIG. 2, the visual media has been split into five cropped portions 230a-230e which are assigned for display by different ones of MD1-MD5. For example, MD2 is assigned to display the upper left cropped portion 230a, MD1 is assigned to display the upper center cropped portion 230b, MD4 is assigned to display the upper right cropped portion 230c, MD3 is assigned to display the lower left cropped portion 230d, and MD5 is assigned to display the lower right cropped portion 230e. As shown in FIG. 2, the media splitting module operations can adjust the physical size, aspect ratio, resolution, and other characteristics of the cropped portions of the visual media based on, for example, the display characteristics of the individual MDs 110. MD1 is oriented in portrait mode with a narrower display component contributing to the virtual playout screen and is responsively assigned a relatively more narrow horizontally cropped portion 230b than the other cropped portions 230a and 230c-230e which are assigned to be displayed on MD2-MD5 oriented in landscape mode.

Moreover, it is noted that MD3 and MD5 have larger display areas than MD1, MD2 and MD4, which the media splitting module operations can be aware of and use to when deciding on size, aspect ratio, and/or resolution for MD3 and MD5 versus MD1, MD2 and MD4. FIG. 2 illustrates that the media splitting module operations have adjusted where cropped portion 230d is displayed by MD3 and where cropped portion 230e is displayed by MD5 to align the left edges of cropped portions 230d and 230a and to align the right edges of cropped portions 230e and 230c, which leaves margins 234 and 236 which are not used by MD3 and MD5, respectively, for displayed any part of the cropped portions 230d and 230e.

Although various operations have been disclosed in the context of using five MDs 110 such as in the manner of FIGS. 1-3, these and other operations disclosed herein are not limited thereto and can be used with any plural number of MDs. For example, operations of the media splitting module to determine how to split the visual media into a set of cropped portions can be adapted based on how many MDs are used to form components of the virtual play out screen. Some further illustrative non-limiting examples of operations shown below to split a visual media based on other numbers of MDs:

1) For two MDs:
a. split the visual media into left and right screen cropped components;
b. split the visual media into top and bottom screen cropped components; or
c. split the visual media into other “free-form location” cropped components.

2) For three MDs:
a. split the visual media into left, middle, and right screen cropped components;
b. split the visual media into top, middle, and bottom screen cropped components; or
c. split the visual media into other “free-form location” cropped components.

3) For four MDs:
a. split the visual media into four quadrants of cropped components, e.g., upper left and upper right screen cropped components and lower left and lower right screen cropped components; or
b. split the visual media into other “free-form location” cropped components.

### Summary of Some Visual Media Splitting and Display Operations:

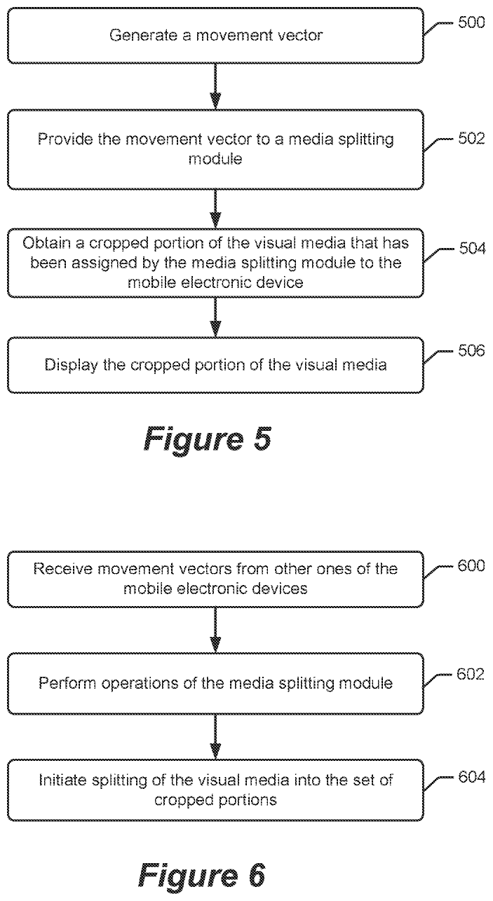

As explained above, aspects of the methods and operations have been described above are not limited to particular disclosed embodiments, but instead are intended to be applicable for any system that can benefit from splitting of digital media for display through a set of MDs that form components of a virtual play out screen. Aspects of these further embodiments are now more generally described with regard to FIGS. 5-7, which are flowcharts of operations that are performed by a master one of the MDs.

Referring to FIG. 5, a MD is configured for operation with an arrangement of MDs to provide a virtual playout screen for visual media. The MD performs operations that generate 500 a movement vector identifying direction and distance that the MD has been moved from a reference location to a playout location where the display device will form a component of the virtual playout screen, based on tracking movement indicated by the movement sensor while being moved. The MD provides 502 the movement vector to a media splitting module that determines how to split the visual media into a set of cropped portions for display on assigned ones of the MDs based on the movement vector. The MD obtains 504 a cropped portion of the visual media that has been assigned by the media splitting module to the MD, and displays 506 the cropped portion of the visual media on a display device.

As explained above regarding FIGS. 3 and 4, the MD can perform 310, 402 virtual screen playout coordination communications that include synchronizing a time reference based on a timing signal that is shared with the other MDs for timing synchronization. The operation to display 506 the cropped portion of the visual media on the display device can include controlling timing of when the cropped portion of the visual media is displayed on the display device responsive to determining occurrence of a time event relative to the time reference.

As explained above, one of the MDs can operate as a master. Referring to FIG. 6, the master MD receives 600 movement vectors from other ones of the MDs. The master MD perform 602 operations of the media splitting module to determine how to split the visual media into the set of cropped portions for display on assigned ones of the MDs based on relative locations of display devices of the MDs when arranged as components of the virtual playout screen. The master MD initiates 604 splitting of the visual media into the set of cropped portions for display on the assigned ones of the MDs.

The master MD may identify 312 occurrence of a trigger event indicative of a user being ready to move individual ones of the MDs from a stacked on top of each other arrangement associated with the reference location to an arrangement spaced apart from the reference location and configured to provide the virtual playout screen for playout of the visual media. The master MD, responsive to identification of the occurrence of the trigger event, communicate 314 a command to the other MDs via a wireless network interface circuit that initiates generation of respective movement vectors by the other MDs when moved to the spaced apart arrangement relative to the reference location, and initiates generation of the movement vector by the MD. Alternatively each of the MDs may separately identify occurrence of a trigger event. The operation to identify occurrence of a trigger event can include identifying occurrence of a momentary vibration that is characteristic of a physical tap by the user on a portion of the master MD or receipt of a defined input from the user via a user input interface of the master MD.

The master MD may be selected to operate as the master to perform the operations of the media splitting module, based on comparison of a media processing capability that is provided by each of the MDs.

The operation of the media splitting module to determine 336 how to split the visual media into the set of cropped portions, can include determining scaling ratios to be applied to scale respective ones of the cropped portions of the visual media for display on assigned ones of the MDs based on media processing capabilities of the assigned ones of the MDs. The media processing capability can include at least one of: display size, display resolution, display bezel size, display color temperature, display brightness, processor speed, memory capacity, and communication quality of service for receiving a cropped portion of the visual media.

The master MD may determine from the movement vectors when a condition is satisfied indicating that one of the MDs has moved at least a threshold distance. Responsive to determining that the condition is satisfied, the master MD may initiate repetition of performance of the operations of the media splitting module to determine how to split the visual media into the set of cropped portions for display on assigned ones of the MDs based on the movement vectors.

The master MD may determine when a condition is satisfied indicating that one of the other MDs is no longer available to operate to display a component of the virtual playout screen. The master MD may respond to the condition becoming satisfied by removing the one of the other MDs from a listing of available MDs. Moreover, responsive to determining that the condition has become satisfied, the master MD may initiate repetition of performance of the operations of the media splitting module to determine how to split the visual media into the set of cropped portions for display on assigned ones of the listing of available MDs.

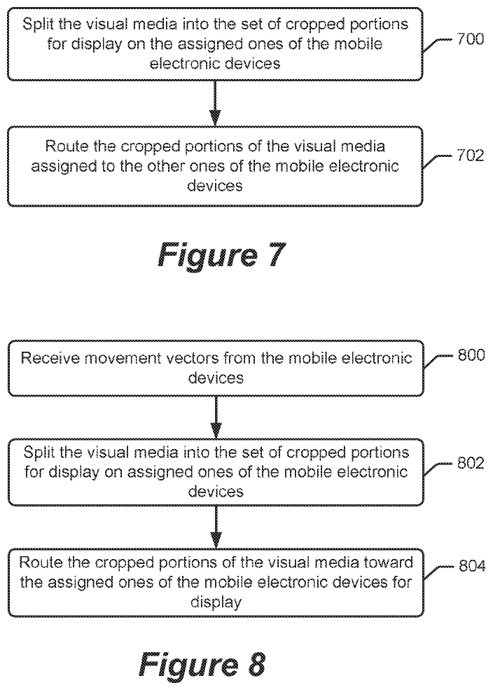

As explained above, the master MD may operate to split the visual media into the set of cropped portions and route the cropped portions to the assigned ones of the MDs. Referring to the associate operations shown in FIG. 7, the master MD may split 700 the visual media into the set of cropped portions for display on the assigned ones of the MDs. The master MD can route 702 the cropped components of the visual media assigned to the other ones of the MDs through the wireless network interface circuit for communication toward the other ones of the MDs for display.

When the master MD is operating according to FIG. 7, the master MD may perform 310, 402 the virtual screen playout coordination communications which include receiving display characteristics from the other ones of the MDs, and obtain the display characteristics of the master MD from local memory or a networked device. The operation to perform 502 the splitting of the visual media into the set of cropped portions for display on the assigned ones of the MDs can include the master MD determining how many of the cropped portions are to be split from the visual media and which of the cropped portions are assigned to which ones of the MDs based on a combination of the display characteristics and the movement vectors of the MDs.

When the media splitting module operations are performed by a media server, the master MD can operate to communicate the movement vector to the media server via a wireless network interface circuit so that the media server can perform the operations of the media splitting module. The master MD can also receive the cropped portion of the visual media from the media server via the wireless network interface circuit.

FIG. 8 is a flowchart of operations that are performed by a media server to perform operations for splitting the visual media into cropped portions which it then routes to the MDs according to with some embodiments of the present disclosure. Referring to FIG. 8, the media server performs operations to receive 800 movement vectors from the MDs. Each of the movement vectors identifies direction and distance that one of the MDs have been moved from a reference location to a playout location where a display device of the MD will form a component of the virtual playout screen. The operations split 802 the visual media into a set of cropped portions for display on assigned ones of the MDs based on the movement vectors. The operations then route 804 the cropped portions of the visual media toward the assigned ones of the MDs for display.

In some further embodiments the splitting operation 802 can include determining scaling ratios to be applied to scale respective ones of the cropped portions of the visual media for display on assigned ones of the MDs based on media processing capabilities of the assigned ones of the MDs. The media processing capability can include at least one of: display size, display resolution, display bezel size, display color temperature, display brightness, processor speed, memory capacity, communication quality of service for receiving a cropped portion of the visual media from the media server.

### Delegation of Visual Media Splitting Operations:

According to some other aspects, the master MD can delegate responsibility for performing the media splitting module operations to another one of the MDs based on one or more defined rules. For example, the master MD may delegate those operations to another MD that has one or more media processing capability that better satisfy a defined rule then the master MD and other MDs, such as by having one or more of a faster processing speed, greater memory capacity, better communication quality of service for receiving the visual media, etc.

### Guiding User Arrangement of MDs for Virtual Playout Screen:

According to some other aspects, the virtual screen application can provide guidance to a user for how to more optimally arrange the MDs to create the virtual playout screen. For example, the application may use the display characteristics of the MDs to compute an optimal arrangement or a set of recommended arrangements for how the MDs should be arranged. In one embodiment, the application determines the optimal arrangement and/or recommended arrangements based on any one or more of the following: the physical sizes of the MD displays, the MD physical sizes, the MD display aspect ratios, the MD display resolutions, and/or the MD display framing widths and/or thicknesses. For example, the arrangement may be computed to necessitate the shortest distances and/or the least amount of rotations during the user's relocation of the MDs to become arranged in the optimal or recommended arrangement as components of the virtual playout screen. The application may determine an amount of overlap for one or more of the MDs by one or more other MDs, such as by having smaller phones overlapping a portion or portions of a tablet computer display. The application may display instructions or other visual indicia and/or provide audible guidance to the user for how to rearrange the MDs to create virtual playout screen.

Adapting to Movement or Loss of an MD that is Part of a Virtual Play out Screen:

According to some other aspects, the virtual screen application can trigger repetition of the operations for splitting the visual media into the cropped portions responsive to determining that one or more of the MDs has been relocated and/or responsive to determining the one or more of the MDs is no longer available for such use.

The media server may redetermine how to split the visual media into a set of cropped portions responsive to determining that at least one of the MDs has been moved. In one embodiment, the operations by the media server include determining from the movement vectors when a condition is satisfied indicating that one of the MDs has moved at least a threshold distance. Responsive to determining that the condition is satisfied, the media server repeats performance of the operation 802 of splitting it into the visual media into the set of cropped portions for display on assigned ones of the MDs.

Alternatively or additionally, the media server may redetermine how to split the visual media into a set of cropped portions responsive to determining that one of the MDs is no longer available. In one embodiment, the operations by the media server include determining when a condition is satisfied indicating that one of the MDs is no longer available to operate to display a component of the virtual playout screen. The operations remove the one of MDs from a listing of available MDs. Responsive to determining that the condition is satisfied, the media server repeats performance of the operation 802 of splitting the visual media into the set of cropped portions for display on assigned ones of the MDs among the listing of available MDs.

Adjusting Media Displayed on MDs Based on their Depths:

According to some other aspects, as explained above the movement sensors and tracking operations can be configured to track movement with respect to any number of axes, such as along three orthogonal axes and rotations about any one or more of the axes. Thus, for example, a user may rearrange the MDs 110 to provide a non-planar three-dimensional arrangement of the MDs 110 to create the virtual playout screen. The operations of the media splitting module can compute from the movement vectors the depths as perpendicular distances between the major planar surfaces of the display devices of the MDs, and can perform responsive operations when generating the cropped components, such as scaling any one or more of the zoom ratio (e.g., magnification), physical size, pixel resolution, or aspect ratio cropped portions that are assigned to various of the MDs based on their respective depths. For example, in one embodiment operations can proportionally increase the zoomed image displayed on a MD based on a distance that it is further away from the major planar surface of a closer MD to the user.

### Propagating a User Change on One MD to Other MDs:

According to some other aspects, the MDs may be configured to allow a user to adjust the zoom magnification of a cropped component of the visual media on one of the MDs and to responsively cause the other MDs to adjust their zoom magnifications of the respective cropped components of visual media that they separately display. For example, in one embodiment the user may use an outward pinch gesture to zoom-in on the cropped component being displayed on one of the MDs to cause that MD and the other MDs to appear to simultaneously and proportionally zoom-in on their respective displayed cropped components. The user may similarly use an inward pinch gesture to zoom-out on the cropped component being displayed on one of the MDs to cause that MD and the other MDs to appear to simultaneously and proportionally zoom-out on their respective displayed cropped components.

### Cloud Implementation

Some or all operations described above as being performed by the MDs and/or the media server may alternatively be performed by another node that is part of a cloud computing resource. For example, those operations can be performed as a network function that is close to the edge, such as in a cloud server or a cloud resource of a telecommunications network operator, e.g., in a CloudRAN or a core network, and/or may be performed by a cloud server or a cloud resource of a media provider, e.g., iTunes service provider.

### Example Mobile Electronic Device and Media Server

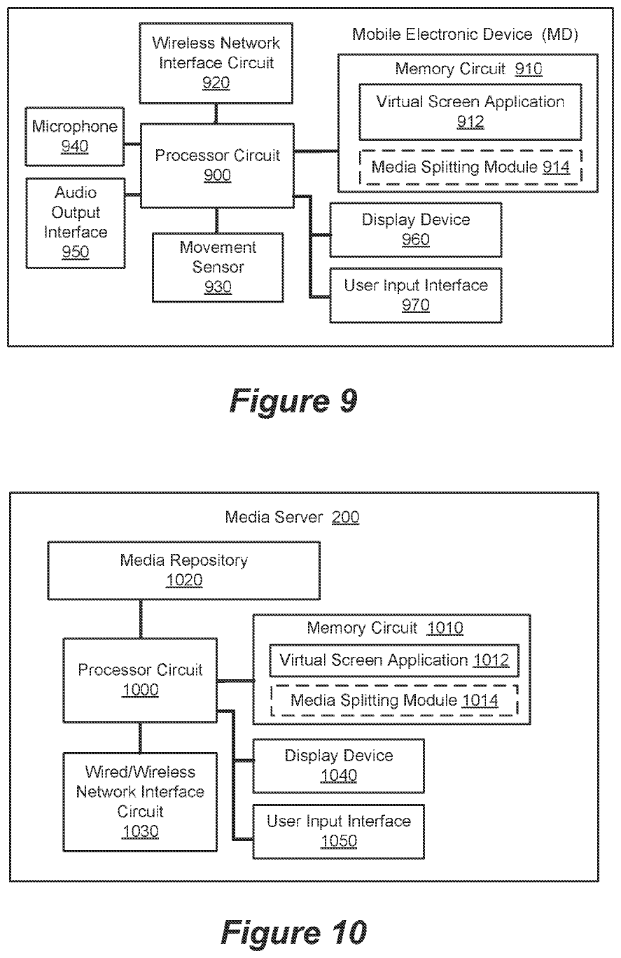

FIG. 9 is a block diagram of components of a mobile electronic device (MD) that are configured in accordance with some other embodiments of the present disclosure. The mobile electronic device can include a wireless network interface circuit 920, a movement circuit 930, a microphone 940, an audio output interface 950 (e.g., speaker, headphone jack, wireless transceiver for connecting to wireless headphones), a display device 960, a user input interface 970 (e.g., keyboard or touch sensitive display), at least one processor circuit 900 (processor), and at least one memory circuit 910 (memory). The processor 900 is connected to communicate with the other components. The memory 910 stores a virtual screen application 912 and may further store a media splitting module 914 that is executed by the processor 900 to perform operations disclosed herein. The processor 900 may include one or more data processing circuits, such as a general purpose and/or special purpose processor (e.g., microprocessor and/or digital signal processor), which may be collocated or distributed across one or more data networks. The processor 900 is configured to execute computer program instructions in the memory 910, described below as a computer readable medium, to perform some or all of the operations and methods for one or more of the embodiments disclosed herein for a mobile electronic device.

In one embodiment the movement sensor 930 includes a multi-axis accelerometer that outputs data indicating sensed accelerations along orthogonal axes. The operation to generate, e.g., 318-326 in FIGS. 3 and 500 in FIG. 5, a movement vector can include integrating the values contained in the data output by the multi-axis accelerometer to determine distance and direction that the mobile electronic device is moved from the reference location to where the display device will form a component of the virtual playout screen.

In another embodiment the movement sensor 930 includes a camera that outputs video. The operation to generate, e.g., 318-326 in FIGS. 3 and 500 in FIG. 5, a movement vector tracking movement of at least one object identifiable in the video to determine distance and direction that the mobile electronic device is moved from the reference location to where the display device will form a component of the virtual playout screen.

FIG. 10 is a block diagram of components of a media server 200 which operate according to at least some embodiments of the present disclosure. The media server 200 can include a network interface circuit 1030, at least one processor circuit 1000 (processor), and at least one memory circuit 1010 (memory). The network interface circuit 1030 is configured to communicate with mobile electronic devices via networks which can include wireless and wired networks. A media repository 1020 may be part of the media server 200 or may be communicatively networked to the media server 200 through the network interface circuit 1030. The media server 200 may further include a display device 1040 and a user input interface 1050. The memory 1010 stores program code that is executed by the processor 1000 to perform operations. The memory 1010 include the virtual screen application 1012 that operates to the visual media from the media repository 1020 and/or components of the visual media to the MDs forming the virtual playout screen, and may include the media splitting module 1014. The processor 1000 may include one or more data processing circuits, such as a general purpose and/or special purpose processor (e.g., microprocessor and/or digital signal processor), which may be collocated or distributed across one or more data networks. The processor 1000 is configured to execute the program code in the memory 1010, described below as a computer readable medium, to perform some or all of the operations and methods for one or more of the embodiments disclosed herein for a map route server.

### Further Definitions and Embodiments

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

1. A mobile electronic device (MD1) configured for operation with an arrangement of mobile electronic devices to provide a virtual playout screen for visual media, the mobile electronic device comprising:
a wireless network interface circuit configured for communication through a wireless communication link;
a movement sensor configured to sense movement of the mobile electronic device;
a display device;
a processor operationally connected to the display device, the wireless network interface circuit, and the movement sensor; and
a memory storing program code that is executed by the processor to perform operations comprising:
generating a movement vector identifying direction and distance that the mobile electronic device has been moved from a reference location to a playout location where the display device will form a component of the virtual playout screen based on tracking movement indicated by the movement sensor while being moved;
providing the movement vector to a media splitting module that determines how to split the visual media into a set of cropped portions for display on assigned ones of the mobile electronic devices based on the movement vector;
obtaining a cropped portion of the visual media that has been assigned by the media splitting module to the mobile electronic device; and
displaying the cropped portion of the visual media on the display device.

2. The mobile electronic device of claim 1, wherein:
the movement sensor comprises a multi-axis accelerometer that outputs data indicating sensed accelerations along orthogonal axes; and
the operation to generate a movement vector comprises integrating the values contained in the data output by the multi-axis accelerometer to determine distance and direction that the mobile electronic device is moved from the reference location to the playout location where the display device will form a component of the virtual playout screen.

3. The mobile electronic device of claim 1, wherein:
the movement sensor comprises a camera that outputs video; and
the operation to generate a movement vector comprises tracking movement of at least one object identifiable in the video to determine the distance and direction that the mobile electronic device is moved from the reference location to the playout location where the display device will form a component of the virtual playout screen.

4. The mobile electronic device of claim 1, wherein the operations further comprise:
performing virtual screen playout coordination communications that comprise synchronizing a time reference based on a timing signal that is shared with the other mobile electronic devices for timing synchronization,
wherein the operation to display the cropped portion of the visual media on the display device comprises controlling timing of when the cropped portion of the visual media is displayed on the display device responsive to determining occurrence of a time event relative to the time reference.

5. The mobile electronic device of claim 1, wherein the operations further comprise:
receiving movement vectors from other ones of the mobile electronic devices;
performing operations of the media splitting module to determine how to split the visual media into the set of cropped portions for display on assigned ones of the mobile electronic devices based on relative locations of display devices of the mobile electronic devices when arranged as components of the virtual playout screen; and
initiating splitting of the visual media into the set of cropped portions for display on the assigned ones of the mobile electronic devices.

6. The mobile electronic device of claim 1, wherein the operations further comprise:
identifying occurrence of a trigger event from a momentary vibration that is characteristic of a physical tap by the user or receipt of a defined input from the user via a user input interface of the mobile electronic device, the trigger event is indicative of a user being ready to move individual ones of the mobile electronic devices from a stacked on top of each other arrangement associated with the reference location to an arrangement spaced apart from the reference location and configured to provide the virtual playout screen for playout of the visual media; and
responsive to identification of the occurrence of the trigger event, communicating a command to the other mobile electronic devices via the wireless network interface circuit that initiates generation of respective movement vectors by the other mobile electronic devices when moved to the spaced apart arrangement relative to the reference location, and initiating generation of the movement vector by the mobile electronic device.

7. The mobile electronic device of claim 1, wherein the operations further comprise:
identifying occurrence of a trigger event from a momentary vibration that is characteristic of a physical tap by the user or receipt of a defined input from the user via a user input interface of the mobile electronic device, the trigger event is indicative of a user being ready to move individual ones of the mobile electronic devices from a stacked on top of each other arrangement associated with the reference location to an arrangement spaced apart from the reference location and configured to provide the virtual playout screen for playout of the visual media; and
responsive to identification of the occurrence of the trigger event, initiating tracking of movement indicated by the movement sensor while the mobile electronic device is being moved.

8. The mobile electronic device of claim 5, wherein the operations further comprise:
selecting the mobile electronic device to operate as a master device that performs the operations of the media splitting module based on comparison of a media processing capability that is provided by each of the mobile electronic devices,
wherein the media processing capability comprises at least one of: display size, display resolution, display bezel size, display color temperature, display brightness, processor speed, memory capacity, and communication quality of service for receiving a cropped portion of the visual media.

9. The mobile electronic device of claim 5, wherein the operation of the media splitting module to determine how to split the visual media into the set of cropped portions comprises:
determining scaling ratios to be applied to scale respective ones of the cropped portions of the visual media for display on assigned ones of the mobile electronic devices based on media processing capabilities of the assigned ones of the mobile electronic devices,
wherein the media processing capability comprises at least one of: display size, display resolution, display bezel size, display color temperature, display brightness, processor speed, memory capacity, and communication quality of service for receiving a cropped portion of the visual media.

10. (canceled)

11. The mobile electronic device of claim 5, wherein the operations further comprise:
determining from the movement vectors when a condition is satisfied indicating that one of the mobile electronic devices has moved at least a threshold distance; and
responsive to determining that the condition is satisfied, repeating performance of the operations of the media splitting module to determine how to split the visual media into the set of cropped portions for display on assigned ones of the mobile electronic devices based on the movement vectors.

12. The mobile electronic device of claim 5, wherein the operations further comprise:
determining when a condition is satisfied indicating that one of the other mobile electronic devices is no longer available to operate to display a component of the virtual playout screen;
removing the one of the other mobile electronic devices from a listing of available mobile electronic devices; and
responsive to determining that the condition is satisfied, repeating performance of the operations of the media splitting module to determine how to split the visual media into the set of cropped portions for display on assigned ones of the listing of available mobile electronic devices.

13. The mobile electronic device of claim 5, wherein the operations further comprise following initiation of the splitting of the visual media into the set of cropped portions:
splitting the visual media into the set of cropped portions for display on the assigned ones of the mobile electronic devices; and
routing the cropped components of the visual media assigned to the other ones of the mobile electronic devices through the wireless network interface circuit for communication toward the other ones of the mobile electronic devices for display.

14. The mobile electronic device of claim 13, wherein the operations further comprise:
performing virtual screen playout coordination communications that comprise receiving display characteristics from the other ones of the mobile electronic devices; and
obtaining display characteristics of the mobile electronic device,
wherein the operation to perform the splitting of the visual media into the set of cropped portions for display on the assigned ones of the mobile electronic devices comprises determining how many of the cropped portions are to be split from the visual media and which of the cropped portions are assigned to which ones of the mobile electronic devices based on a combination of the display characteristics and the movement vectors of the mobile electronic devices.

15. The mobile electronic device of claim 1, wherein:
the operation to provide the movement vector to the media splitting module comprises communicating the movement vector to a media server via a wireless network interface circuit, the media server performing operations of the media splitting module; and
the operation to obtain a cropped portion of the visual media that has been assigned by the media splitting module to the mobile electronic device comprises receiving the cropped portion of the visual media from the media server via the wireless network interface circuit.

16. A media server configured for communication with an arrangement of mobile electronic devices that provide a virtual playout screen for visual media, the media server comprising:
a network interface circuit configured for communication with the mobile electronic devices;
a processor operationally connected to the network interface circuit; and
a memory storing program code that is executed by the processor to perform operations comprising:
receiving movement vectors from the mobile electronic devices, each of the movement vectors identifying direction and distance that one of the mobile electronic devices have been moved from a reference location to a playout location where a display device of the mobile electronic device will form a component of the virtual playout screen;
splitting the visual media into a set of cropped portions for display on assigned ones of the mobile electronic devices based on the movement vectors; and
routing the cropped portions of the visual media toward the assigned ones of the mobile electronic devices for display.

17. The media server of claim 16, wherein the operation of the splitting the visual media into the set of cropped portions comprises:
determining scaling ratios to be applied to scale respective ones of the cropped portions of the visual media for display on assigned ones of the mobile electronic devices based on media processing capabilities of the assigned ones of the mobile electronic devices;
wherein the media processing capability comprises at least one of: display size, display resolution, display bezel size, display color temperature, display brightness, processor speed, memory capacity, communication quality of service for receiving a cropped portion of the visual media from the media server.

18. (canceled)

19. The media server of claim 16, wherein the operations further comprise:
determining from the movement vectors when a condition is satisfied indicating that one of the mobile electronic devices has moved at least a threshold distance; and
responsive to determining that the condition is satisfied, repeating performance of the operation of splitting the visual media into the set of cropped portions for display on assigned ones of the mobile electronic devices.

20. (canceled)

21. The media server of claim 16, wherein the operations further comprise:
performing virtual screen playout coordination communications that comprise receiving display characteristics from the mobile electronic devices; and
wherein the operation to split the visual media into the set of cropped portions for display on assigned ones of the mobile electronic devices comprises determining how many of the cropped portions are to be split from the visual media and which of the cropped portions are assigned to which ones of the mobile electronic devices based on a combination of the display characteristics and the movement vectors.

22. A method by a mobile electronic device operating with an arrangement of mobile electronic devices to provide a virtual playout screen for visual media, the method comprising:
generating a movement vector identifying direction and distance that the mobile electronic device has been moved from a reference location to a playout location where a display device will form a component of the virtual playout screen based on tracking movement indicated by a movement sensor of the mobile electronic device while being moved;
providing the movement vector to a media splitting module that determines how to split the visual media into a set of cropped portions for display on assigned ones of the mobile electronic devices based on the movement vector;
obtaining a cropped portion of the visual media that has been assigned by the media splitting module to the mobile electronic device; and
displaying the cropped portion of the visual media on the display device.

23. (canceled)

24. (canceled)

25. A method by a media server communicating with an arrangement of mobile electronic devices that provide a virtual playout screen for visual media, the method comprising:
receiving movement vectors from the mobile electronic devices, each of the movement vectors identifying direction and distance that one of the mobile electronic devices have been moved from a reference location to a playout location where a display device of the mobile electronic device will form a component of the virtual playout screen;
splitting the visual media into a set of cropped portions for display on assigned ones of the mobile electronic devices based on the movement vectors; and
routing the cropped portions of the visual media toward the assigned ones of the mobile electronic devices for display.

26. (canceled)

27. (canceled)
